(19) United States
(12) Patent Application Publication
(10) Pub. No.: US 2009/0063638 A1
(43) Pub. Date: Mar. 5, 2009

(54) Method and Apparatus for Processing Messages in Messaging System

(76) Inventors: Lei Guo, San Diego, CA (US); Erich Miles Nahum, New York, NY (US); John Michael Tracey, Scarsdale, NY (US); Dinesh Chandra Verma, Mount Kisco, NY (US); Xiping Wang, Scarsdale, NY (US); Charles P. Wright, Cortlandt Manor, NY (US); Zhen Xiao, White Plains, NY (US)

Correspondence Address: RYAN, MASON & LEWIS, LLP, 90 FOREST AVENUE, LOCUST VALLEY, NY, 11560, US

(21) Appl. No.: 11/846,850

(22) Filed: Aug. 29, 2007

(51) Int. Cl. G06F 15/16

(52) U.S. Cl. 709/206

(57) ABSTRACT

Techniques are disclosed for processing messages in a messaging system, particularly during an overload condition. For example, a method of processing messages of an instant messaging system includes the following steps. A message from a first instant messaging user is received during an overload condition. A message type associated with the received message is determined. The method then decides whether to send the message to a second instant messaging user based on the determined message type of the received message. In another method, processing messages in an instant messaging system includes the following steps. Presence information associated with a first instant messaging system user is received. The presence information is sent to a second instant messaging system user when the second messaging system user requests the presence information associated with the first instant messaging system user.

### FIELD OF THE INVENTION

The present invention generally relates to messaging systems and, more particularly, to techniques for processing messages in such messaging systems.

### BACKGROUND OF THE INVENTION

Instant Messaging (IM) is an extremely popular software application. In general, IM offers a form of real-time communication between two or more people based primarily on typed text. The text is conveyed via computers (forming a messaging system) connected over a network such as the Internet. Some popular IM services include AIM™ (America Online LLC of Dulles, Va.), MSN Live Messenger™ (Microsoft Corporation of Redmond, Wash.), Yahoo Messenger™ (Yahoo! Inc. of Sunnyvale, Calif.) and Gtalk™ (Google Inc. of Mountain View, Calif.).

It is estimated that there are tens of millions of instant messaging users all over the world. Private users typically use instant messaging to keep in touch with friends and families, while corporate users typically exchange instant messages to discuss work. Compared to other methods of communication, instant messaging offers several advantages. Its almost synchronous nature makes it ideal for simple requests and responses. Instant messaging also typically provides presence and event notification which makes it easy to keep track of the availability of colleagues and friends (“buddies” in IM terminology). In addition, most instant messaging systems today incorporate support for voice or video chats as well as file transfer, making it an integrated environment for a wide variety of communication needs.

Almost all major instant messaging systems route messages through centralized servers. However, due to the large volume of instant messages, these servers can act as significant system bottlenecks, especially during severe overload conditions. Current messaging systems do not adequately optimize message processing during such overload conditions.

### SUMMARY OF THE INVENTION

Principles of the invention provide techniques for processing messages in a messaging system, particularly during an overload condition. The messaging system may preferably be a real-time or instant messaging system.

For example, in one aspect of the invention, a method of processing messages of an instant messaging system includes the following steps. A message from a first instant messaging user is received during an overload condition. A message type associated with the received message is determined. The method then decides whether to send the message to a second instant messaging user based on the determined message type of the received message.

The message is preferably not sent to the second instant messaging user when the message type is a presence message type or a hint message type. The message is preferably sent to the second instant messaging user when the message type is a text message (e.g., chat message) type.

The message type determining step may further include parsing a header of the received message to determine the message type. The deciding step may further include applying a processing policy based on the message type of the received message. The receiving, determining and deciding steps may be performed in a server of the instant messaging system or a proxy of the instant messaging system. A communication protocol used by the instant messaging system may include a Session Initiation Protocol (SIP). An article of manufacture may include a processor-readable storage medium storing one or more software programs which when executed by a processor perform the receiving, determining and deciding steps.

In another aspect of the invention, a method of processing messages in an instant messaging system includes the following steps. Presence information associated with a first instant messaging system user is received. The presence information is sent to a second instant messaging system user when the second messaging system user requests the presence information associated with the first instant messaging system user.

The second instant messaging system user may request the presence information associated with a first instant messaging system user by selecting the first instant messaging system user on a display of the second instant messaging system user. The presence information may be sent when the second instant messaging system user clicks on a corresponding icon of the first instant messaging system user. The presence information may be sent when a representation of the first instant messaging system user is displayed in an instant messaging window of the second instant messaging system user. The representation of the first instant messaging system user may be one of an icon and a name of the first instant messaging system user. The presence information may be sent based on at least one of a temporal proximity (e.g., recent) and a frequency of communications (e.g., frequent) between the first instant messaging user and the second instant messaging user. The presence information may be sent, when a chat window is attempted by the second instant messaging system user to the first instant messaging system user. The receiving and sending steps may be performed in one of a server of the instant messaging system and a proxy of the instant messaging system. An article of manufacture may include a processor-readable storage medium storing one or more software programs which when executed by a processor perform the receiving and sending steps.

In yet another aspect of the invention, a method of processing messages of a messaging system during an overload condition includes receiving messages from messaging system users, sending one or more of the received messages that are of a substantive communication type, and discarding one or more of the received messages that are of a nonessential message type. The method may also assign a discard probability to a message based on the type of the message.

Apparatus for processing messages of a messaging system during an overload condition may includes a memory, and a processor coupled to the memory and operative to perform the receiving, sending and discarding steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of an instant messaging system in which principles of the invention may be implemented.

FIG. 2 shows a method implemented by one or more servers in the messaging system according to an embodiment of the invention.

FIG. 3 shows a method implemented by one or more servers in the messaging system according to another embodiment of the invention.

FIG. 4 shows a method for processing presence messages in an on-demand manner according to an embodiment of the invention.

FIG. 5 illustrates the use of one or more proxies in a messaging system according to an embodiment of the invention.

FIG. 6 shows a computer system in which principles of the invention may be implemented.

### DETAILED DESCRIPTION OF PREFERRED EMBODIMENTS

While illustrative embodiments of the invention will be described herein in the context of instant messaging applications, it is to be understood that principles of the invention are more generally applicable to any type of messaging system.

Various IM-related phrases and terms will be used herein. However, it is to be understood that principles of the invention are not intended to be limited to the illustrative definitions given below. For example, as used herein, the phrase “chat messages” refers to text messages sent and received by users wherein the users are substantively communicating (“chatting”) with one another. “Hint messages” are messages generated by the IM client software when a user is typing or editing a message. A user may, for example, hold off her own typing when she receives a hint message that indicates that her buddy is currently responding. A “buddy” is a frequent contact with whom a user chats with online. A “buddy list” is a contact list that enables the user to know when their contacts are online and can communicate. “Presence messages” are messages used to notify the status of buddies in a user's buddy list. A user can see who is online, who is offline, who is away (still online but not available to chat), etc. “Icon and binary messages” are messages used to upload a user defined picture to the instant messaging server, to download the picture of buddies from the instant messaging server, or to deliver voice/video chat and file transfer packets when the two users cannot communicate directly. Typically, file transfer, voice/video chats, etc., are conducted between the two users directly without going through the server. However, if both users are behind firewalls, then the communication has to be relayed by the server. “Service control messages” are messages for controlling log in and log out, server redirection, application level keep alive, etc.

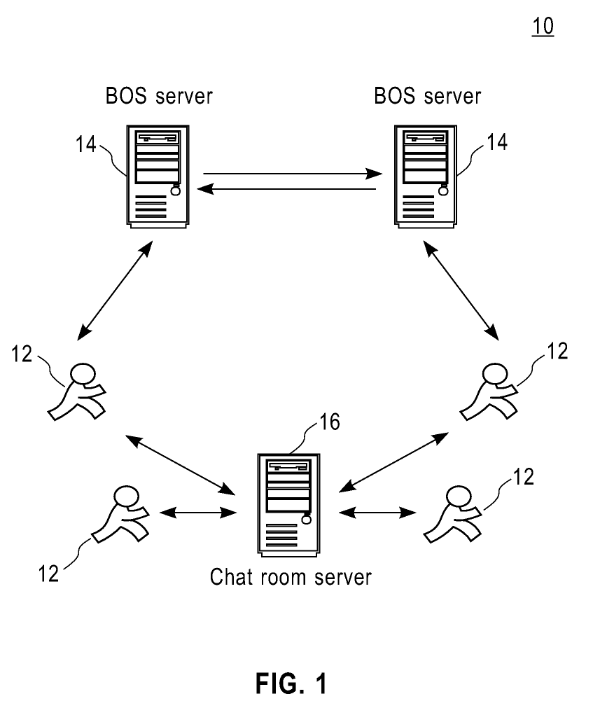

FIG. 1 shows an example of an instant messaging system. In particular, FIG. 1 shows a simplified representation of an AIM™ type messaging system 10. In messaging system 10, several users 12 communicate (via respective computing devices, not shown) through chat room server 16. The users also communicate with BOS (Basic OSCAR Service) servers 14. BOS refers to the services that form the core of the instant messaging service, i.e., login/logoff, locate, instant message, roster management, information management and buddy list. OSCAR stands for Open System for Communication in Real-time.

While this architecture facilitates firewall traversal and gives instant messaging service providers more control over its subscribers (users 12), it creates a potential bottleneck at the servers. This is especially so for large instant messaging operators with tens of millions of users and during flash crowd events (i.e., events that cause a sudden spike in the volume of IM traffic and, thus, an overload condition).

Principles of the invention address the problem by providing techniques for optimizing message processing during overload conditions. In one embodiment, this is accomplished by determining which messages to discard and how to process presence information when instant messaging servers are overloaded.

One solution to protect instant messaging servers from being overloaded may include dropping messages based on customer types or revenue expectation. For example, a service provider could offer several levels of service to its customers. During overload, it can prioritize messages from premium customers (who pay more) while dropping messages from ordinary customers (who may sign up for free).

The main drawback of such a solution is that it does not take advantage of the specific characteristics of instant messaging traffic, i.e., not all instant messages are equally important.

We have realized that a large percentage of (if not most) instant messaging traffic is due to “nonessential traffic” (or nonessential messages). By way of example, as used in the illustrative embodiments herein, “nonessential traffic” may include traffic other than chat messages, e.g., nonessential messages may include, but not be limited to, presence messages and hint messages. Thus, principles of the invention utilize this realization and provide for an instant messaging server to protect the instantaneous nature of the communication passing through it by dropping some or all nonessential traffic during overload. Such a methodology may result in significant load reduction for instant messaging servers. This solution may be complementary to solutions that drop messages based on customer types or revenue expectations. The inventive solution has the advantage of being minimally intrusive because the nonessential traffic it drops is unlikely to cause major inconvenience to instant messaging users.

We also realized that the fact that presence information represents a significant portion of instant messaging traffic is partly due to the broadcast nature of the presence traffic. That is, when the presence status of an instant messaging user changes, such information will be propagated to all of her buddies (users on her buddy list), thus potentially creating a flood of messages. Another aspect of the invention is to process presence information in an on-demand fashion (i.e., when it is really needed), as will be explained in detail below.

Principles of the invention are based on the insights we gained from a measurement study we conducted of instant messaging traffic in a major enterprise network. We found that a large percentage of instant messaging traffic is due to nonessential traffic, while chat messages (i.e., substantive communication messages) constitute only a small percentage of the total instant messaging traffic. Therefore, according to principles of the invention, IM servers (e.g., chat servers and BOS servers in FIG. 1) can protect the instantaneous nature of the communication during an overload condition by not routing (i.e., dropping or discarding) nonessential traffic.

For example, if a hint message is dropped, then a user may not be notified that her buddy is in the process of replying to her. This fact, however, will become apparent when she eventually receives the text message (chat message) from her buddy. For most users, the delivery of hint messages is less important than the delivery of the actual text messages. As another example, if presence messages are periodically refreshed, then a user may have an out-of-date view of the availability of her buddy when a presence message is dropped, e.g., she may think her buddy is online while her buddy has gone offline. This information, however, can be refreshed during the next interval or when she actually sends a message to her buddy. Hence, dropping some presence messages periodically, while causing minor annoyance, is more acceptable than dropping text messages.

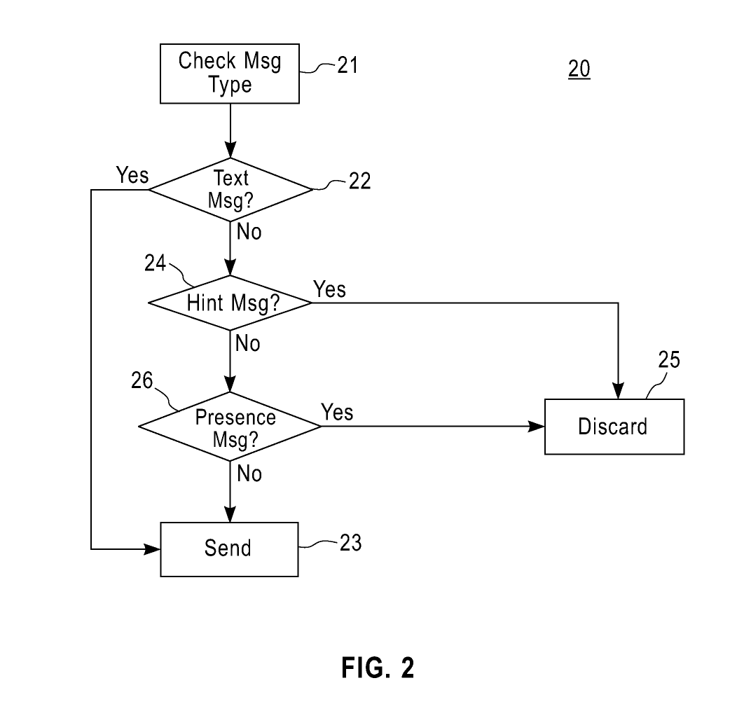

FIG. 2 shows an example flow of a methodology where hint and presence messages are discarded during overload, while text and other types of messages are delivered.

Thus, method 20 can be implemented in one or more (preferably all) of the servers in the messaging system (e.g., chat servers and BOS servers in FIG. 1, or any servers in the messaging system that route messages). The server first checks the message type (step 21). If it is a text message (step 22), the message is sent (step 23). If not a text message, but rather a hint message (step 24), the message is discarded (step 25). If not a hint message, but rather a presence message (step 26), the message is also discarded (step 25). If neither a text, hint or presence message, the message is also sent (step 23).

It is understood that the above embodiment is just one of the many possible implementations of principles of the invention. Thus, other embodiments that drop nonessential messages without delivering them to the end users may be implemented. Also, such processing may include selective discard of icon messages used to display instant messaging users' images.

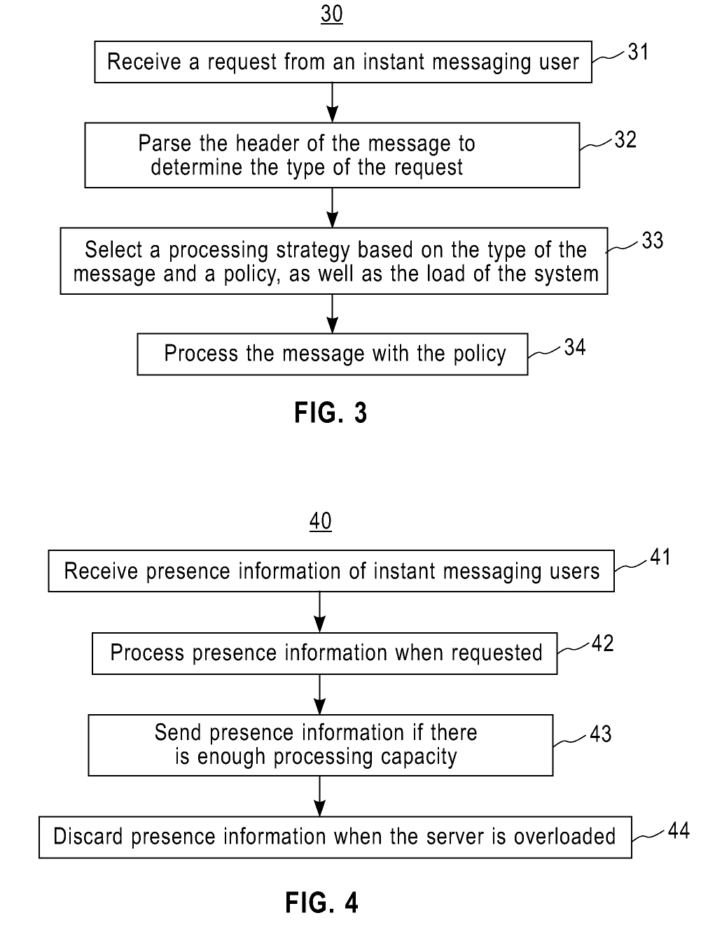

More generally, FIG. 3 illustrates a method implemented by one or more (preferably all) servers in the messaging system. As shown, method 30 receives a request from an instant messaging user (step 31). The server parses the header of the message to determine the type of the request (step 32)—e.g., the message type. The server selects a processing strategy based on the type of the message and a particular policy, as well as the load of the system (step 33). The server processes the message with the policy (step 34). In one embodiment, the policy may correspond to method 20 of FIG. 2.

In addition, as part of the selected policy, the messaging system may assign a discard probability to messages based on their types. For example, presence messages may have 30% probability of being discarded, icon messages may have 50% probability of being discarded, while text messages may have 0% probability of being discarded.

As previously mentioned, we realized that presence related traffic contributes to a substantial fraction of the overall instant messaging traffic. In current instant messaging systems, the presence update is automatically propagated to all related instant messaging users. For example, if an instant messaging user is included in the buddy list of 100 other users, then whenever this user changes her status (e.g., going online, offline, away, do not disturb, etc.), her status will be propagated by the instant messaging server to the 100 users. While this allows those users to have a quick view on her presence, it creates a potentially large amount of traffic on the instant messaging server and may adversely impact the processing of other types of traffic.

Thus, principles of the invention provide for the processing of presence traffic in an on-demand (i.e., when requested) manner, i.e., the presence information is processed only when an instant messaging user explicitly requests the presence of her buddy. Note that an average instant messaging user can have a large number of buddies. She may not care about the presence of all of them most of the time. In addition, the presence information is refreshed periodically, i.e., a user can go online, offline, away, and come back. Hence, a piece of presence information can become obsolete before it is used by the instant messaging user.

There are several ways we can determine whether or not an instant messaging user wants to know the presence of her buddy. In one embodiment, the presence information is sent when a user clicks on the corresponding icon of her buddy. In another embodiment, the presence information is sent when a user moves her cursor over the icon of her buddy. In yet another embodiment, the presence information is sent when the icon of the buddy is displayed in the user's instant messaging window. This is useful if the user has several screens of buddies, not all of which can be displayed at the same time. In a further embodiment, the presence information is sent when a chat window is attempted to the buddy. In yet another embodiment, the presence information is sent when a group is expanded to reveal individual members. Instant messaging software can organize buddies into groups, e.g., friends, relatives, work, etc. When a group is collapsed, the individual members are not visible. When the group is expanded, those members become visible. Thus, in this particular embodiment, presence information is sent when the user chooses to expand a particular group to reveal individual members of that group. It is understood that the above are just examples and are not intended to limit the scope of the invention.

In an additional example, the instant messaging system may request user presence information based on recent and/or frequent communications. For example, if an instant messaging user has communicated with a particular buddy frequently in the near past, the system may request the presence information of that particular buddy more often than that of other buddies.

FIG. 4 shows a method for processing presence messages in an on-demand manner. As shown, in method 40, the server receives presence information of instant messaging users (step 41). The server processes the presence information when requested by a user (step 42), e.g., when a user wants to know the presence of her buddy (triggered in accordance with one of the on-demand presence embodiments mentioned above). The server can also decide to send presence information if there is enough processing capacity (step 43). That is, if the server is operating below some predetermined threshold capacity (e.g., central processing unit (CPU) utilization), it can send presence information whether or not presence information is requested by a user. On the other hand, the server discards some (send only upon request) or all (send none) presence information when the server is overloaded, i.e., at or above the CPU utilization threshold (step 44).

Principles of the invention also provide for offloading message processing to one or more proxies. Proxies can assist servers in the processing of instant messaging. In particular, nonessential traffic can be absorbed by proxies without ever reaching servers. Presence information can also be processed and stored at the proxies until it is requested by the user at which time it can be forwarded to the server for processing in an on-demand manner. The use of proxies is especially beneficial during server overload such as flash crowd events, or when the network is overloaded.

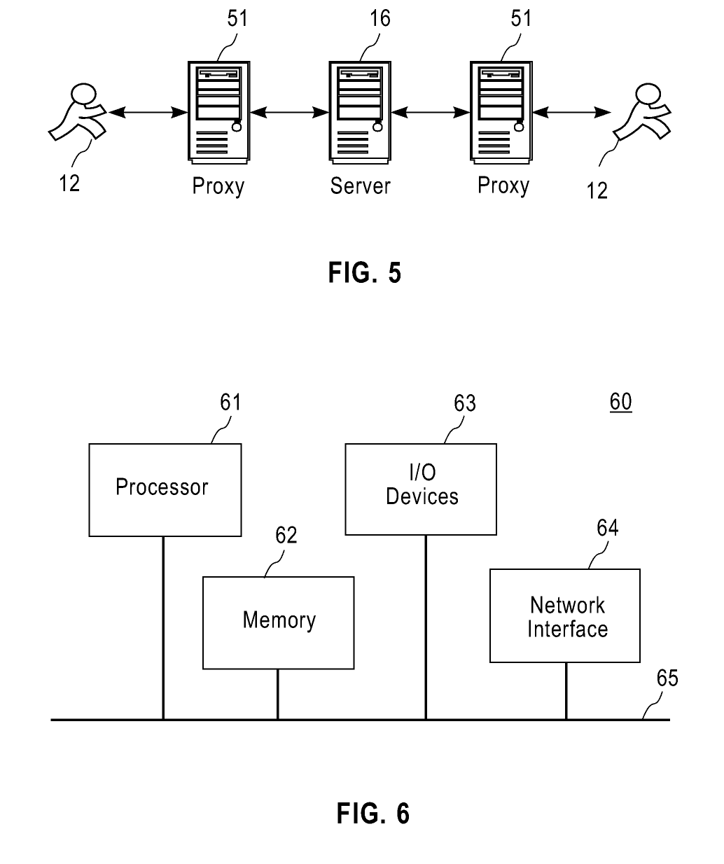

FIG. 5 illustrates the use of proxies in a messaging system. As shown, proxies 51 are located between the instant messaging users 12 and the chat server 16. A proxy, for example, can itself be a server separate from the chat server, or a different processing unit within the chat server.

Data paths in the messaging system may include voice and video chats relayed by the servers and/or proxies when both parties in the conversations are behind firewalls or network address translators (NATs).

FIG. 6 shows a computer system wherein techniques for message processing may be implemented according to an embodiment of the invention. That is, FIG. 6 illustrates a computer system in accordance with which one or more components/steps of the message processing techniques (e.g., components and methodologies described above in the context of FIGS. 1 through 5) may be implemented, according to an embodiment of the invention. It is to be understood that the individual components/steps may be implemented on one such computer system or on more than one such computer system. In the case of an implementation on a distributed computing system, the individual computer systems and/or devices may be connected via a suitable network, e.g., the Internet. However, the system may be realized via private or local networks. In any case, the invention is not limited to any particular network.

Thus, the computer system shown in FIG. 6 may represent one or more servers or one or more other processing devices capable of providing all or portions of the functions described herein.

As shown, computer system 60 includes processor 61, memory 62, input/output (I/O) devices 63, and network interface 64, coupled via a computer bus 65 or alternate connection arrangement.

It is to be appreciated that the term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of processing messages of an instant messaging system, comprising the steps of:
receiving a message from a first instant messaging user during an overload condition;
determining a message type associated with the received message; and
deciding whether to send the message to a second instant messaging user based on the determined message type of the received message.

2. The method of claim 1, wherein the message is not sent to the second instant messaging user when the message type is a presence message type.

3. The method of claim 1, wherein the message is not sent to the second instant messaging user when the message type is a hint message type.

4. The method of claim 1, wherein the message is sent to the second instant messaging user when the message type is a text message type.

5. The method of claim 1, wherein the message type determining step further comprises parsing a header of the received message to determine the message type.

6. The method of claim 1, wherein the deciding step further comprises applying a processing policy based on the message type of the received message.

7. The method of claim 1, wherein the receiving, determining and deciding steps are performed in a server of the instant messaging system.

8. The method of claim 1, wherein the receiving, determining and deciding steps are performed in a proxy of the instant messaging system.

9. An article of manufacture comprising a processor-readable storage medium storing one or more software programs which when executed by a processor perform the steps of the method of claim 1.

10. A method of processing messages in an instant messaging system, comprising the steps of:
receiving presence information associated with a first instant messaging system user; and
sending the presence information to a second instant messaging system user when the second messaging system user requests the presence information associated with the first instant messaging system user.

11. The method of claim 10, wherein the second instant messaging system user requests the presence information associated with a first instant messaging system user by selecting the first instant messaging system user on a display of the second instant messaging system user.

12. The method of claim 11, wherein the presence information is sent when the second instant messaging system user clicks on a corresponding icon of the first instant messaging system user.

13. The method of claim 11, wherein the presence information is sent when a representation of the first instant messaging system user is displayed in an instant messaging window of the second instant messaging system user.

14. The method of claim 11, wherein the presence information is sent based on at least one of a temporal proximity and a frequency of communications between the first instant messaging user and the second instant messaging user.

15. The method of claim 11, wherein the presence information is sent when a chat window is attempted by the second instant messaging system user to the first instant messaging system user.

16. The method of claim 10, wherein the receiving and sending steps are performed in one of a server of the instant messaging system and a proxy of the instant messaging system.

17. An article of manufacture comprising a processor-readable storage medium storing one or more software programs which when executed by a processor perform the steps of the method of claim 11.

18. A method of processing messages of a messaging system during an overload condition, comprising the steps of:
receiving messages from messaging system users;
sending one or more of the received messages that are of a substantive communication type; and
discarding one or more of the received messages that are of a nonessential message type.

19. The method of claim 18, further comprising the step of assigning a discard probability to a message based on the type of the message.

20. Apparatus for processing messages of a messaging system during an overload condition, comprising:
a memory; and
a processor coupled to the memory and operative to: (i) receive messages from messaging system users; (ii) send one or more of the received messages that are of a substantive communication type; and (iii) discard one or more of the received messages that are of a nonessential message type.
